(19) United States
(12) Patent Application Publication
(10) Pub. No.: US 2012/0162821 A1
(43) Pub. Date: Jun. 28, 2012

(54) WRITE HEAD WITH ROTATIONAL WRITE FIELD

(75) Inventors: Quan-Chiu Harry Lam, San Jose, CA (US); Donald G. Allen, Morgan Hill, CA (US); Yansheng Luo, Fremont, CA (US)

(73) Assignee: Hitachi Global Storage Technologies Netherlands B.V., San Jose, CA (US)

(21) Appl. No.: 12/979,208

(22) Filed: Dec. 27, 2010

(51) Int. Cl. G11B 5/127

(52) U.S. Cl. 360/125.03; G9B/5.04

(57) ABSTRACT

The present disclosure describes various ways to achieve a rotational write field using a single coil. For example, a rotational write field can be achieved with a single coil by using different yoke lengths for different poles of a write element. Also described are ways to achieve a rotational write field with a single coil by varying the resistivity, saturation flux density, or pole width of the different poles of the write element of the present invention. The present disclosure also describes various ways to achieve a rotational write field using varied windings of a single coil.

### FIELD OF THE INVENTION

The present invention generally relates to the field of computer hard disks. More particularly, the present invention relates to an improved write head for use in computer hard disks.

### BACKGROUND OF THE INVENTION

Hard disk technology is constantly evolving. Advances in nanomagnetics, magnetic ultrathin films, magnetoelectronics, as well as device processing, have advanced this technology. It can be expected that the future will continue to bring further advances in hard disk technology.

The recording head of a hard disk has three main components: (1) the read sensor (“reader”); (2) the write transducer (“writer”), which is a microfabricated planar electromagnet with a narrow pole that creates a high density of magnetic flux in proximity to the media; and (3) the slider, which is a shaped piece of substrate (typically alumina-titanium carbide) onto which the writer and read sensor are built, and is engineered to “fly” only a few nanometers above the spinning media disk.

The writer is designed to fly just a few nanometers above a spinning disk at up to 15000 revolutions per minute.

The subject of the present invention is the writer, but it is understood that for any writer, there is an appropriate combination of sensor and slider which forms a coherent recording head device and, together with the chosen media, mechanical characteristics, and electronics, forms a complete recording system. The recording environment in which the head is expected to operate is first introduced, including media characteristics, magnetic interference and shielding, and signal-to-noise (SNR) considerations. These constraints put specific boundaries on the sizes, geometries, and magnetic properties which a writer must achieve.

The magnetic recording process utilizes a thin film transducer for the creation or writing of magnetized regions (bits) onto a thin film disk and for the detection or reading of the presence of transitions between the written bits. The thin film transducer is referred to as a thin film head. It consists of a read element, which detects the magnetic bits, and a write element, which creates or erases the bits.

In order to meet the ever increasing demand for improved data rate and data capacity, research has focused on the development of perpendicular recording systems. A traditional longitudinal recording system stores data as magnetic bits oriented longitudinally along a track in the plane of the surface of the magnetic disk. This longitudinal data bit is recorded by a fringing field that forms between a pair of magnetic poles separated by a write gap.

A perpendicular recording system, on the other hand, records data as magnetic transitions oriented perpendicular to the plane of the magnetic disk. FIG. 1 is a schematic of the recording process in a perpendicular recording system. Shown in FIG. 1 is read sensor 102, write element 104, and recording medium 106. The perpendicular write element 104 has a write pole with a very small cross section and a return pole having a much larger cross section. A strong, highly concentrated magnetic field emits from write pole 114 in a direction perpendicular to recording medium 106 to magnetize perpendicular bits 108. Perpendicular write element 104 writes magnetic transitions vertically within recording medium 106 by orienting the magnetic field 116 perpendicular to the direction of recording medium 106. Magnetic field 116 created by this perpendicular head returns through a magnetically soft underlayer 110 within the medium. In this way the recording medium 106 lies within the write gap.

The resulting magnetic flux returns through return pole 112 where it is sufficiently spread out and weak that it will not erase the signal recorded by write element 104. The resulting perpendicular write fields 116 can be up to two times larger than longitudinal write fields, thus enabling the perpendicular write element to write information on high coercivity media that is inherently more thermally stable. In perpendicular recording, the bits do not directly oppose each other resulting in a significantly reduced transition packing. This allows bits to be more closely packed with sharper transition signals, facilitating easier bit detection and error correction. During a read operation, read sensor 102 detects perpendicular bits 108 on recording medium 106.

In a disk recording system, successive bits are written onto the disk surface in concentric rings or tracks separated by a guard band. The head transducer is attached to a suspension, and the suspension is attached to an actuator which controls the position of the transducer in a plane above the disk surface. A specially-designed topography on the lower surface of the slider (known as the air bearing surface or ABS) allows the head to “fly” above the rotating disk (typically 4200-15000 rpm), and controls the height of the transducer above the disk surface, typically 10 to 15 nm.

Referring now to FIG. 2, there is shown an implementation of a disk drive 200. As shown in FIG. 2, at least one rotatable magnetic disk 212 is supported on a spindle 214 and rotated by a disk drive motor 218. The magnetic recording on each disk is in the form of annular patterns of concentric data tracks on the magnetic disk 212.

At least one slider 213 is positioned near the magnetic disk 212, each slider 213 supporting one or more magnetic head assemblies 221. As the magnetic disk rotates, slider 213 moves radially in and out over the disk surface 222 so that the magnetic head assembly 221 may access different tracks of the magnetic disk where desired data are written. Each slider 213 is attached to an actuator arm 219 by way of a suspension 215.

Suspension 215 provides a spring force which biases slider 213 against disk surface 222. Each actuator arm 219 is attached to actuator 227. Actuator 227 as shown in FIG. 2 may be a voice coil motor (VCM). The VCM comprises a coil movable within a fixed magnetic field, the direction and speed of the coil movements being controlled by the motor current signals supplied by controller 229.

During operation of the disk storage system, the rotation of magnetic disk 212 generates an air bearing between slider 213 and the disk surface 222 which exerts an upward force or lift on the slider. The air bearing thus counterbalances the spring force of suspension 215 and supports slider 213 off and slightly above the disk surface by a small, substantially constant spacing during normal operation.

The various components of the disk storage system are controlled in operation by control signals generated by control unit 229. Control signals may also include internal clock signals. Typically, control unit 229 comprises logic control circuits, digital storage and a microprocessor. Control unit 229 generates control signals to control various system operations such as drive motor control signals on line 223 and head position and seek control signals on line 228. The control signals on line 228 provide the desired current profiles to optimally move and position slider 213 to the desired data track on disk 212. Write and read signals are communicated to and from write and read heads 221 by way of recording channel 225.

With reference to FIG. 3, the orientation of magnetic head 221 in slider 213 can be seen in more detail. FIG. 3 is an ABS view of slider 213, and as can be seen, the magnetic head, including an inductive write head and a read sensor, is located at a trailing edge of the slider.

The above description of a typical magnetic disk storage system, and the accompanying illustrations of FIG. 1-3 are for representation purposes only. It should be apparent that disk storage systems may contain a large number of disks and actuators, and each actuator may support a number of sliders.

In a conventional perpendicular writer, switching of the media magnetization is facilitated by adding a top gap field to assist in tilting the total write field at an angle Φ to the media magnetization. This angle is constant since the gap field Hg and perpendicular field Ho are in phase with each other. Because an initial switching torque is proportional to sin(Φ), the larger the tilting, the larger the torque, if everything else were the same. But tilting at a large angle requires generating a larger top gap field Hg, which shunts flux away from the perpendicular writing field Ho itself. So the tilting angle is intrinsically limited.

Therefore, there is a need to provide a large enough tilt angle, at least during the initial switching phase, while not shunting flux away from the write field.

### SUMMARY OF THE INVENTION

The present invention provides for a perpendicular write element that generates a rotational write field during the write operation. The write element of the present invention generates a total write field that is rotational in nature, with the gap field Hg leading slightly in phase. Such a rotational write field has the advantage that, at the initial phase of the switching process, a leading Hg will be applied to a magnetized bit at substantially close to 90 degrees (i.e. substantially close to a maximized tilt angle). As the magnetized bit begins to rotate, the write element of the present invention applies a perpendicular field Ho that will join in with the Hg to continue to rotate and switch the magnetization of the bit of interest. In this way, the write element of the present invention applies a tilt angle that is larger from a conventional writer without shunting flux.

The present disclosure describes various ways to achieve a rotational write field using a single coil. For example, a rotational write field can be achieved with a single coil by using different yoke lengths for different poles of a write element. Also described are ways to achieve a rotational write field with a single coil by varying the resistivity, saturation flux density, or pole width of the different poles of the write element of the present invention. The present disclosure also describes various ways to achieve a rotational write field using varied windings of a single coil.

### BRIEF DESCRIPTION OF THE DRAWINGS

The following drawings will be used to more fully describe embodiments of the present invention.

FIG. 1 is schematic illustration of a disk drive reader and sensor.

FIG. 2 is a schematic illustration of a disk drive system in which the invention might be embodied.

FIG. 3 is an ABS view of a slider illustrating the location of a magnetic head thereon.

FIG. 4 is an illustration of a write element according to the prior art.

FIG. 5 is an illustration of the application of a magnetic field to a magnetized bit.

FIG. 6 is an illustration of the application of a magnetic field to a magnetized bit.

FIG. 7-11 are graphs demonstrating advantages of the present invention.

FIG. 12 is an illustration of write coil according to the prior art.

FIG. 13 is an illustration of write coil according to the present invention.

FIG. 14 is an illustration of write coil according to the present invention.

FIG. 15 is an illustration of write coil according to the present invention.

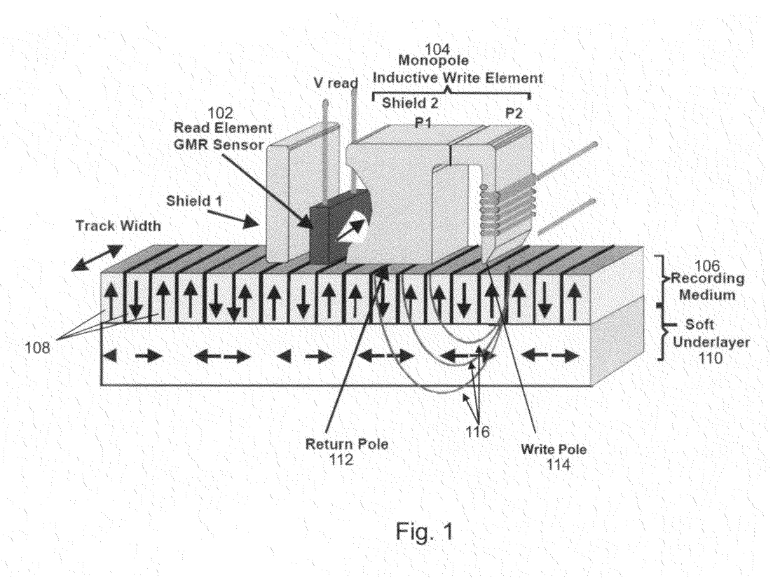

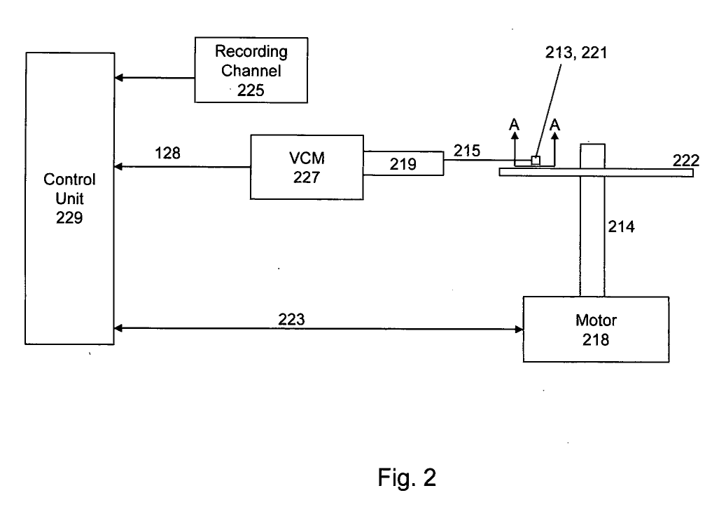

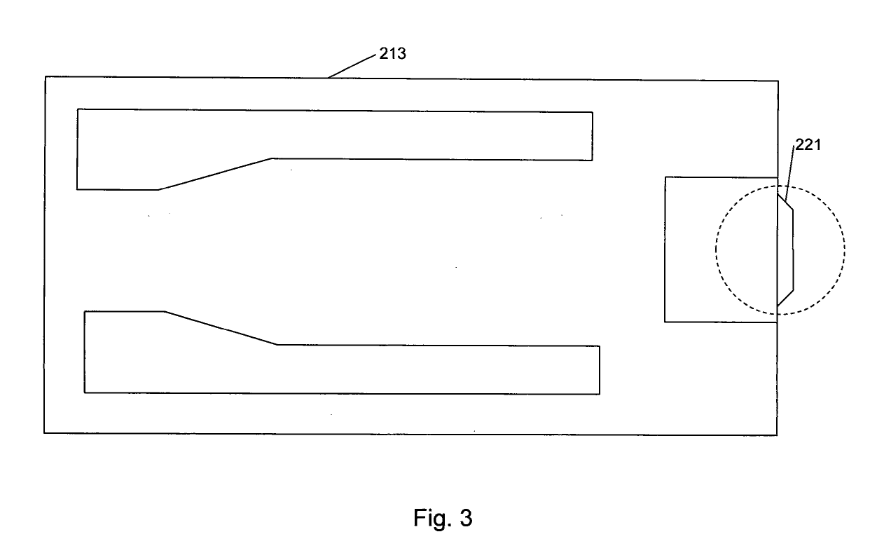

### DETAILED DESCRIPTION OF THE INVENTION

The following description is of certain preferred embodiments presently contemplated for carrying out this invention. This description is made for the purpose of illustrating the general principles of this invention and is not meant to limit the inventive concepts claimed herein.

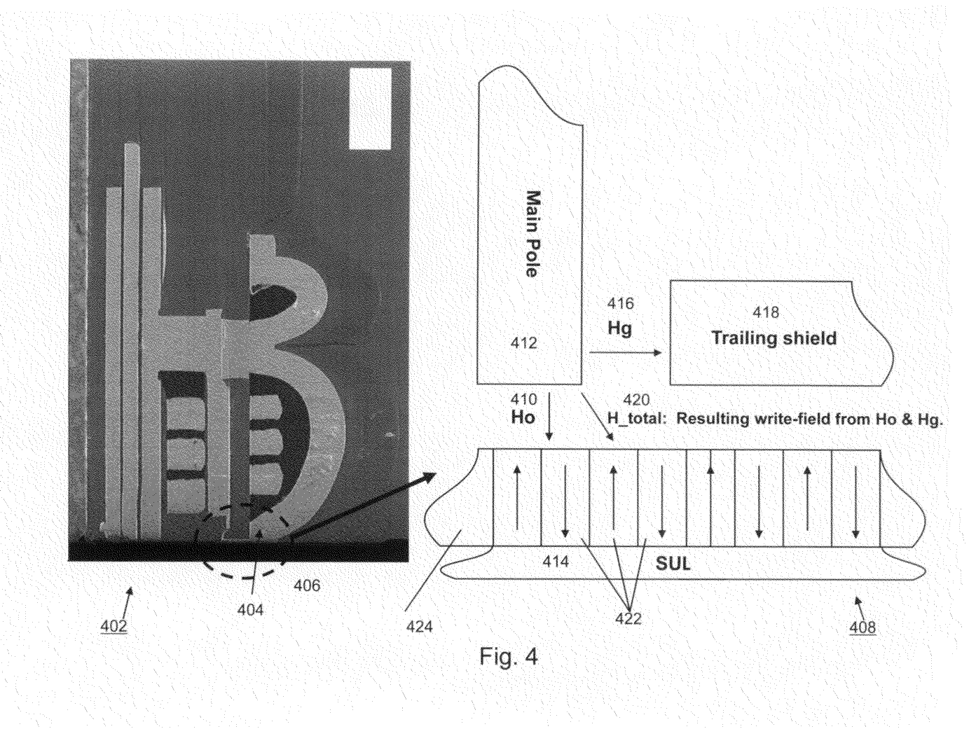

The present invention will be described with reference to FIGS. 4-15 where reference numbers will be used to refer to various structures. It should be understood that where the same numbers are used amongst the figures the same or substantially the same structure is referenced.

Shown in FIG. 4 is an SEM image of a perpendicular writer 402 with trailing shield 404 as shown in area 406. Area 406 is schematically shown as perpendicular writer section 408. As shown in perpendicular writer section 408, perpendicular magnetic write field Ho 410 is generated between the main pole 412 and the soft under layer 414. Also, top gap field Hg 416 is generated between main pole 412 and trailing shield 418. In combination, Ho 410 and Hg 416 tilts total write field H_total 420 at an angle to the magnetic bits 422 on perpendicular media 424. The angle of H_total 420 facilitates the switching of magnetic bits 422.

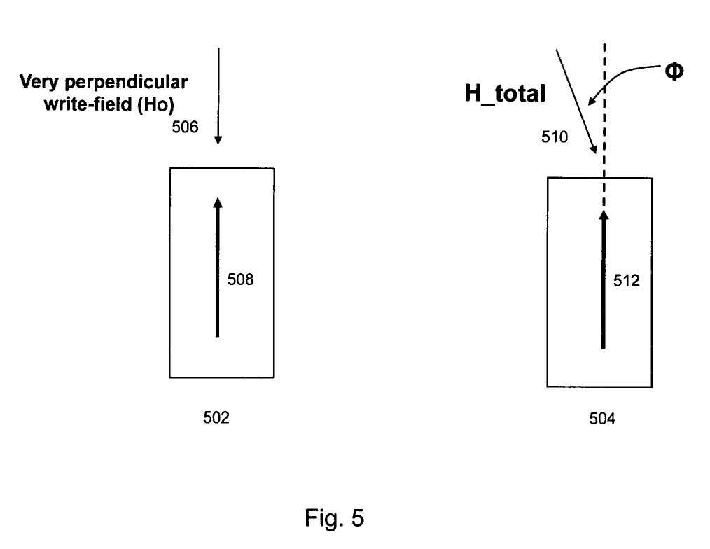

Bits 502 and 504 of FIG. 5 illustrate this point. With reference first to bit 502, a write field Ho 506 is shown that is very close to perpendicular to the media that contains bit 502. When write field Ho 506 is very close to perpendicular to the media, write field Ho 506 is almost directly opposing the moment 508 of bit 502 resulting in an initial switching torque that is small.

With reference now to bit 504, total write field H_total 510 is shown as tilted at an angle φ to the media that contains bit 504. At this angle, total write field H_total 510 is not directly opposing the moment 512 of bit 504 resulting in a higher switching torque than for bit 502. The angle Φ, therefore, facilitates switching bit 504 because the switching torque is proportional to the sine of Φ.

In a conventional perpendicular writer, switching of the media magnetization is generally facilitated by adding a top gap field to assist in tilting the total write field at an angle Φ to the media magnetization. In such a conventional writer, this angle Φ is constant because the gap field Hg and perpendicular field Ho are always in phase with each other. Since the switching torque is proportional to the sine of Φ, the larger the tilting, the larger the torque, if everything else were the same. But tilting at a large angle means generating a larger top gap field Hg which shunts flux away from the perpendicular writing field Ho itself. So the tilting angle can be limited in its benefits.

Whereas the angle Φ of the total write field is constant in a conventional writer, the present invention introduces a changing angle Φ by, for example, having a rotational write field that has a phase leading gap field Hg. Such a rotational write field has the advantage that, at the initial phase of the switching process, a small Hg will start to apply magnetization at substantially close to 90 degrees (i.e., substantially close to a maximum tilt angle). In turn, when the media's magnetization starts to rotate, the perpendicular field Ho will contribute to the Hg to further rotate and switch the magnetization, all at a tilt angle that is larger than it would otherwise be in a conventional writer.

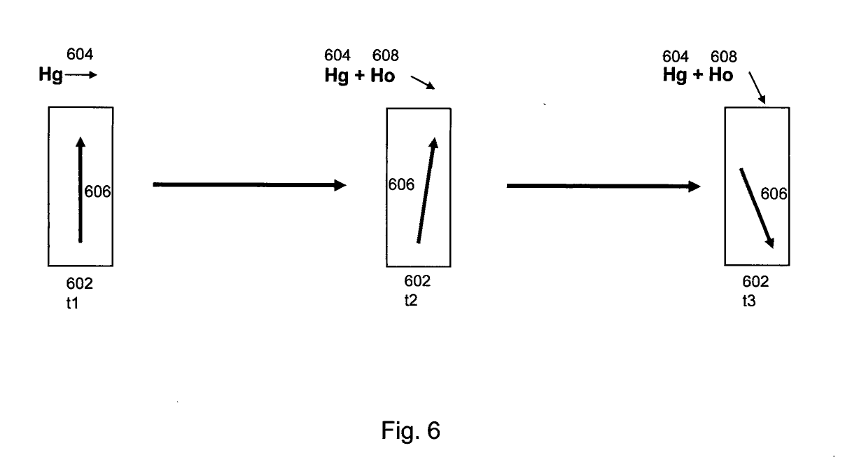

FIG. 6 is helpful in understanding the general effects of a rotational write field. Shown in FIG. 6 is bit 602 at three different times t1, t2, and t3. As shown at time t1, Hg 604, with a leading phase, is generally perpendicular to moment 606 of bit 602. At time t1, therefore, Hg 604 starts to rotate moment 606 with a large effect. At a later time t2, Hg 604 and Ho 608 contribute to switching bit 602. As shown at time t2, however, with moment 606 now slightly turned due to the initial effect of Hg 604, the combined effect of Hg 604 and Ho 608 is increased to facilitate the continued switching of bit 602. At a later time t3, switching of bit 602 is nearly complete as enhanced by a larger tilt angle throughout the switching process.

In the development of the present invention, it has been observed that having a faster rise time in a trailing shield gap field (Hg) when compared to the perpendicular field (Ho) is equivalent to achieving a rotational write field.

As part of the development of the present invention, simulations were performed to simulate the effects of a rotating field on the switching of magnetization. In such simulation, model calculations using the Landau-Lifshitz-Gilbert description of magnetization reversal was used, namely,

$$- [ \frac{1 + {α}^{2}}{Y} ] \frac{d M}{d t} = ( M \times H ) + ( \frac{α}{M} ) M \times ( M \times H )$$

where

H=total field,

α=Gilbert damping,

Y=gyromagnetic constant.

Calculations were performed on a hypothetical media grain with a uniaxial anisotropy (Hk) of 7 kOe in the z direction. A Gilbert damping of 0.3 was used. The components of M, in particular Mz, were simulated as functions of time, comparing the effects of different values of δa on the switching of the magnetization. A field of H was simulated as being applied to the grain with a specified angle to the z direction ranging from 20 to 45 degrees as will be further discussed with reference to the figures.

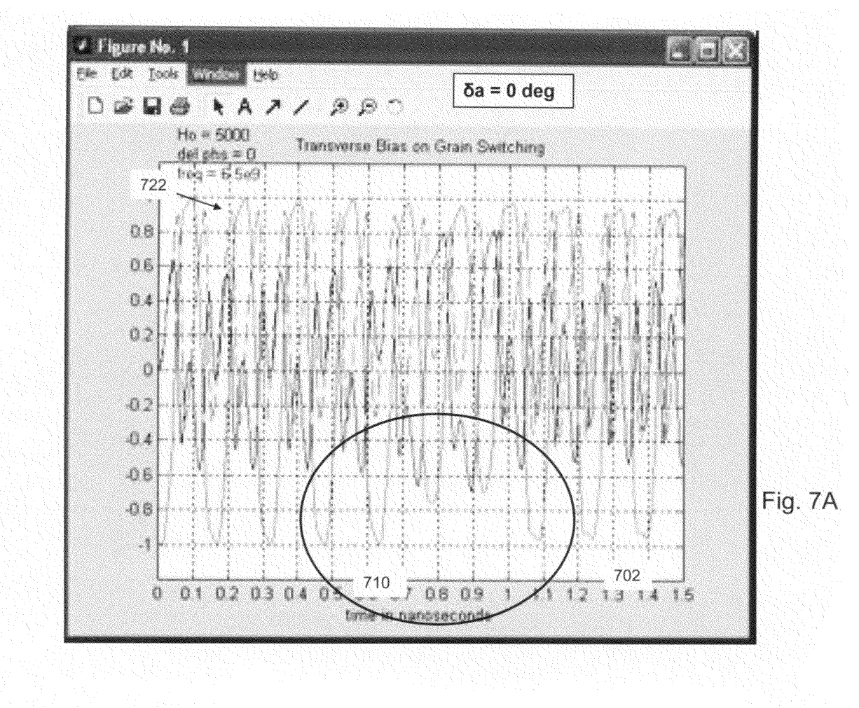

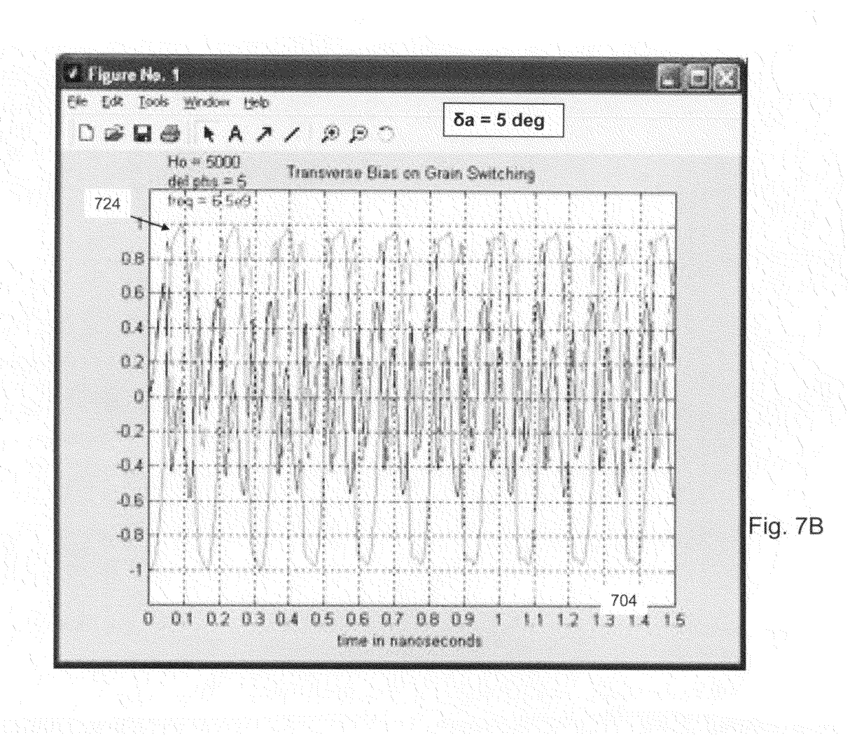

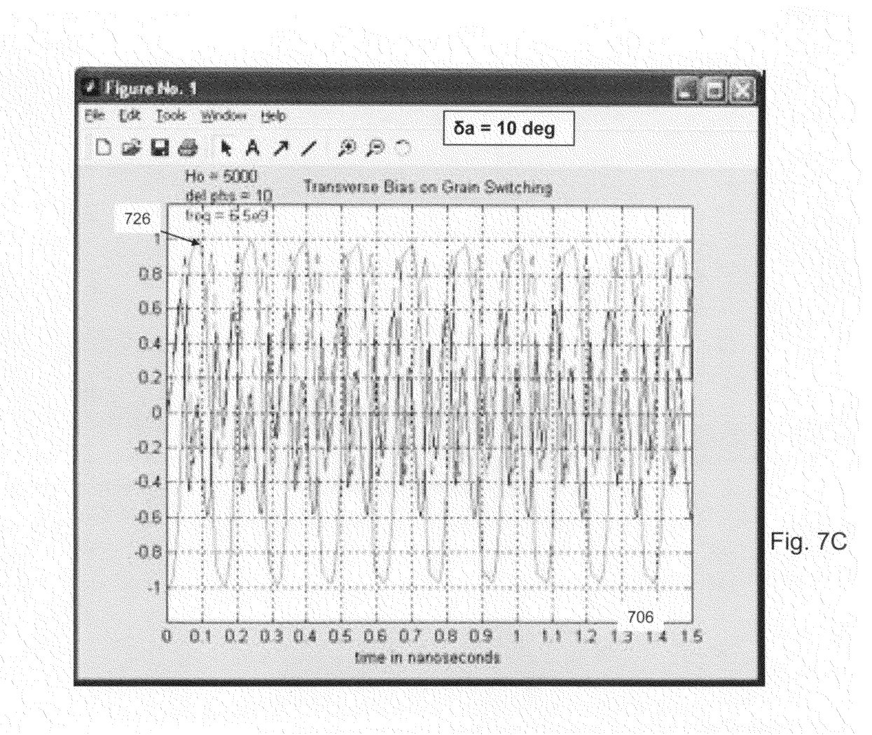

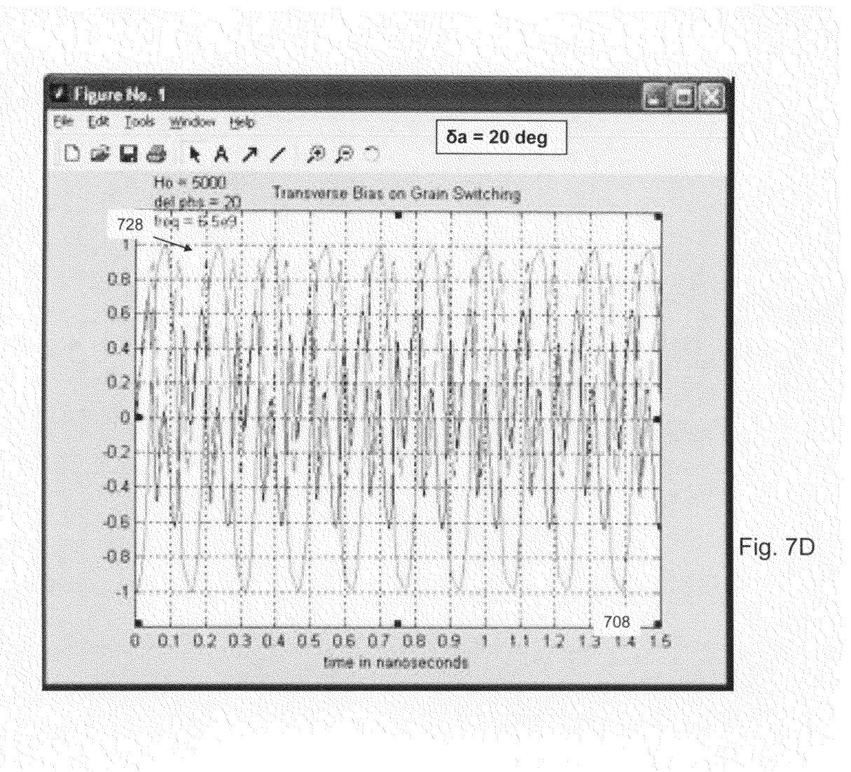

Shown in FIG. 7 are the results of simulating a switching frequency of 6.5 GHz with a total applied field of 5 kOe and an applied angle from the z direction of 45 degrees. Rise time ratio is the ratio of H1_risetime to H2_risetime. Lines 722, 724, 726, and 728 in FIG. 7 correspond to the z-component of grain magnetization (normalized to 1). Graph 702 shows the results of a leading phase &i of zero degrees; graph 704 shows the results of a leading phase δa of 5 degrees; graph 706 shows the results of a leading phase δa of 10 degrees; graph 708 shows the results of a leading phase δa of 20 degrees.

Notable is that with δa of zero degrees problems are observed as noted in circle 710 where complete magnetization switching is not achieved. Contrastingly, graphs 706 and 708 with δa of 10 and 20 degrees, respectively, demonstrate efficient switching. Even graph 704 with a more moderate δa of 5 degrees shows marked improvement over the conditions of graph 702.

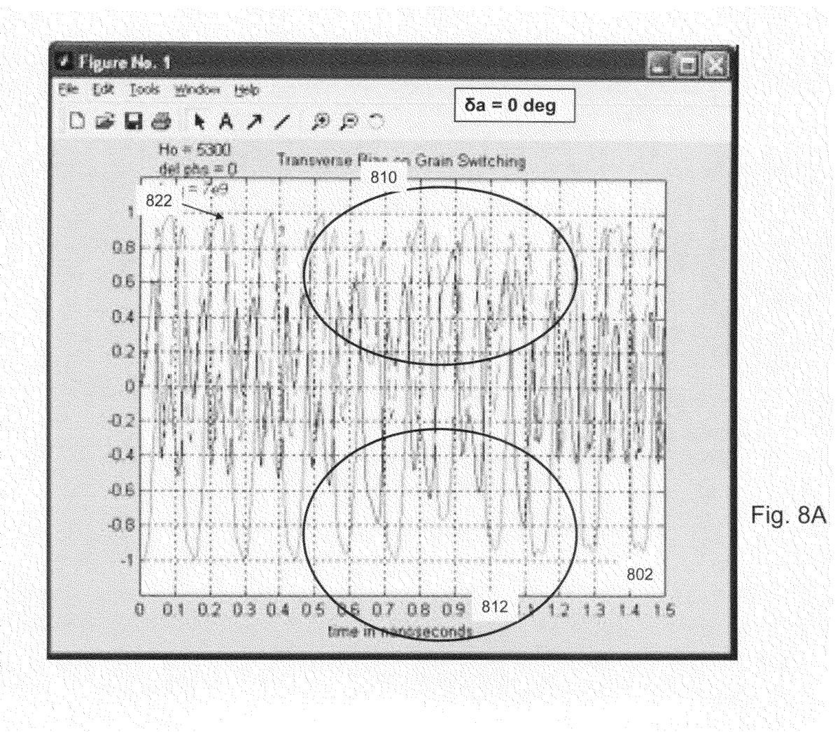

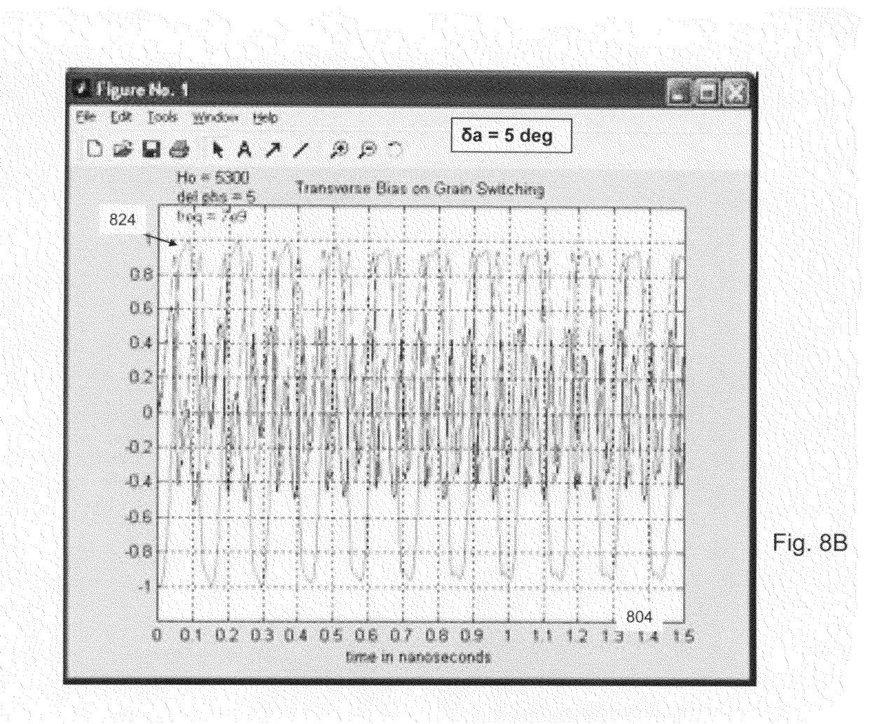

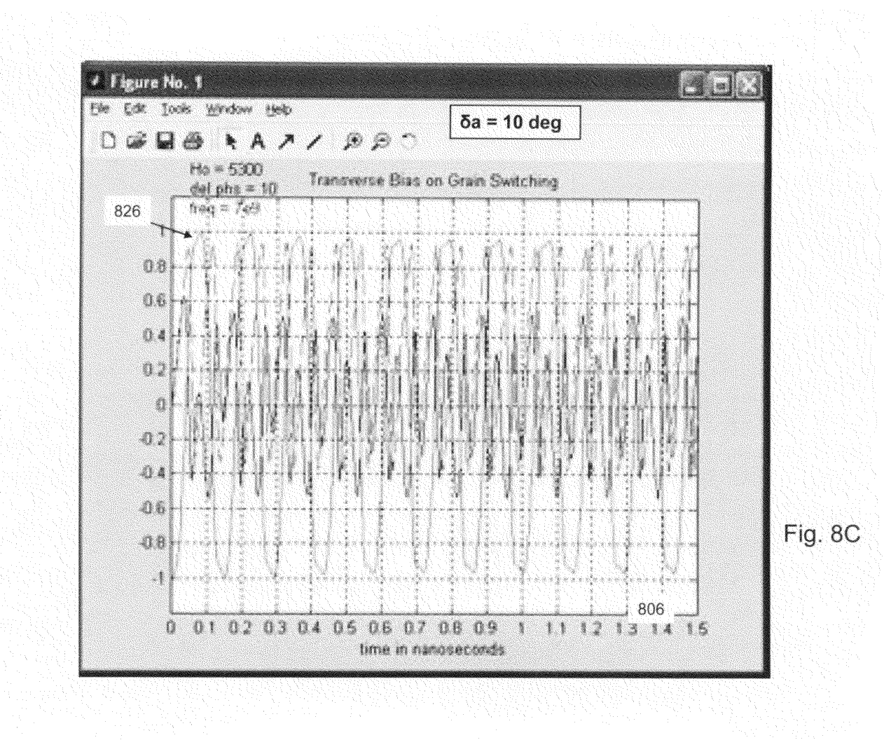

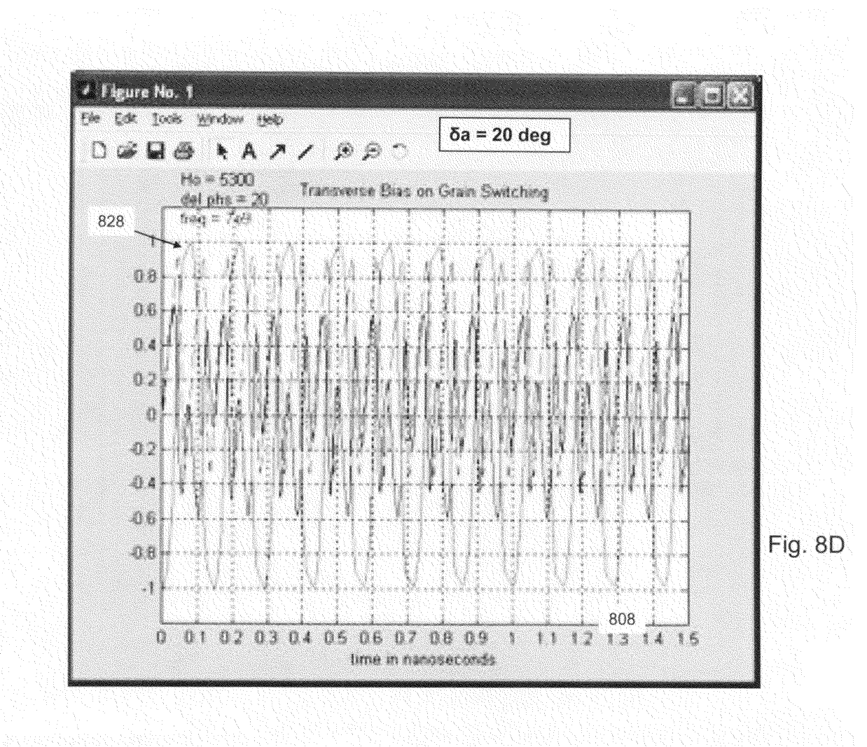

Shown in FIG. 8 are the results of simulating a switching frequency of a switching frequency of 7 GHz (higher than the simulation of FIG. 7) with a total applied field of 5.3 kOe (greater than for the simulation of FIG. 7) and an applied angle from the z direction of 30 degrees (smaller than the simulation of FIG. 7). Rise time ratio is the ratio of H1_risetime to H2_risetime. Lines 822, 824, 826, and 828 in FIG. 8 correspond to the z-component of grain magnetization (normalized to 1). Graph 802 shows the results of a leading phase δa of zero degrees; graph 804 shows the results of a leading phase δa of 5 degrees; graph 806 shows the results of a leading phase δa of 10 degrees; graph 808 shows the results of a leading phase δa of 20 degrees.

Notable is that with δa of zero degrees problems are observed as noted in circles 810 and 812 where complete magnetization switching is not achieved. Contrastingly, graphs 806 and 808 with δa of 10 and 20 degrees, respectively, demonstrate efficient switching. Even graph 804 with a more moderate δa of 5 degrees shows marked improvement over the conditions of graph 802.

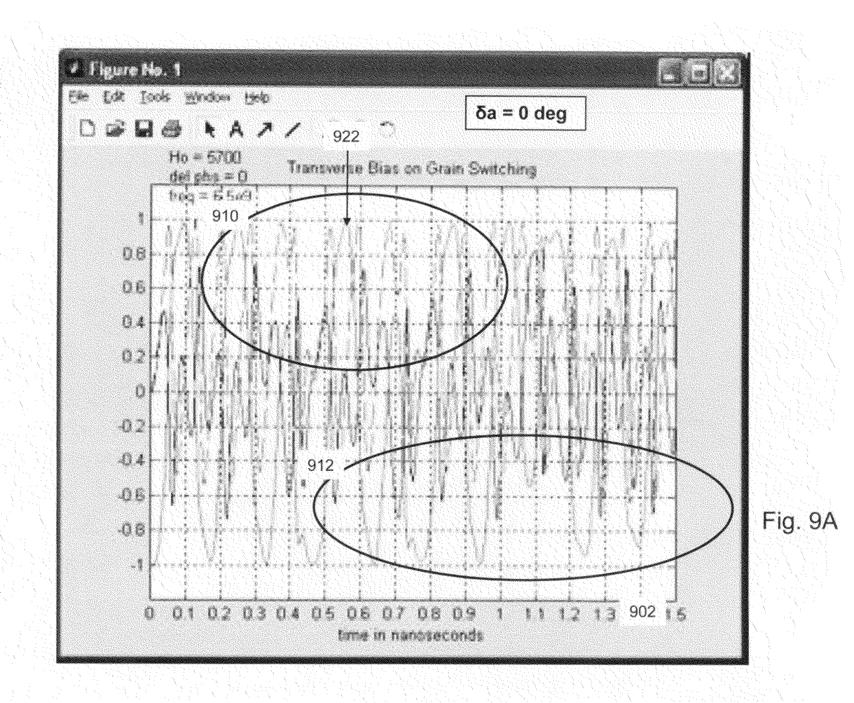

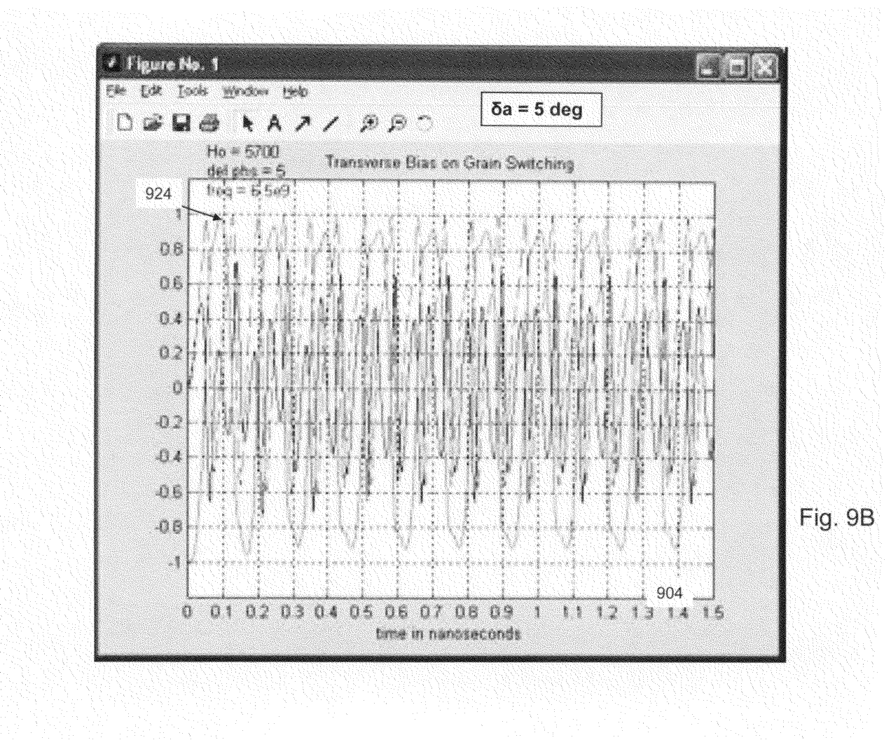

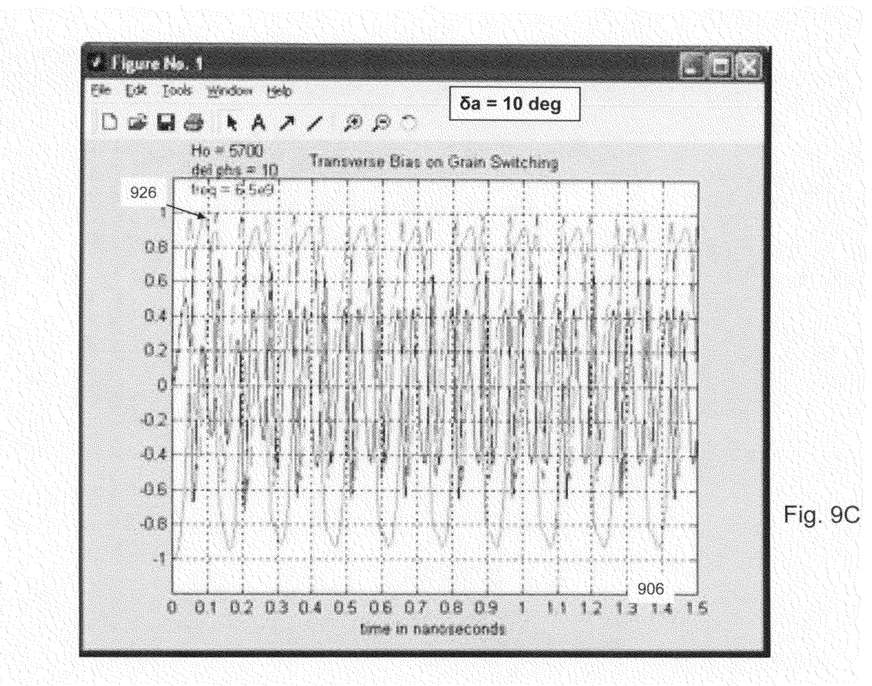

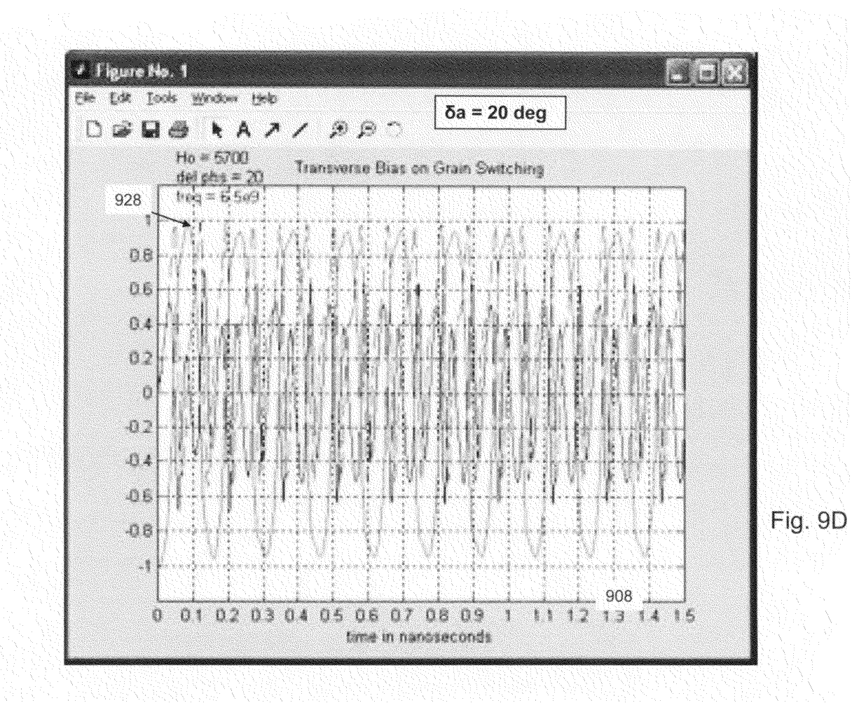

Shown in FIG. 9 are the results of simulating a switching frequency of a switching frequency of 6.5 GHz with a total applied field of 5.7 kOe and an applied angle from the z direction of 30 degrees. Rise time ratio is the ratio of H1_risetime to H2_risetime. Lines 922, 924, 926, and 928 in FIG. 9 correspond to the z-component of grain magnetization (normalized to 1). Graph 902 shows the results of a leading phase δa of zero degrees; graph 904 shows the results of a leading phase δa of 5 degrees; graph 906 shows the results of a leading phase δa of 10 degrees; graph 908 shows the results of a leading phase δa of 20 degrees.

Notable is that with δa of zero degrees problems are observed as noted in circles 910 and 912 where complete magnetization switching is not achieved. Contrastingly, graphs 906 and 908 with δa of 10 and 20 degrees, respectively, demonstrate efficient switching. Even graph 904 with a more moderate δa of 5 degrees shows marked improvement over the conditions of graph 902.

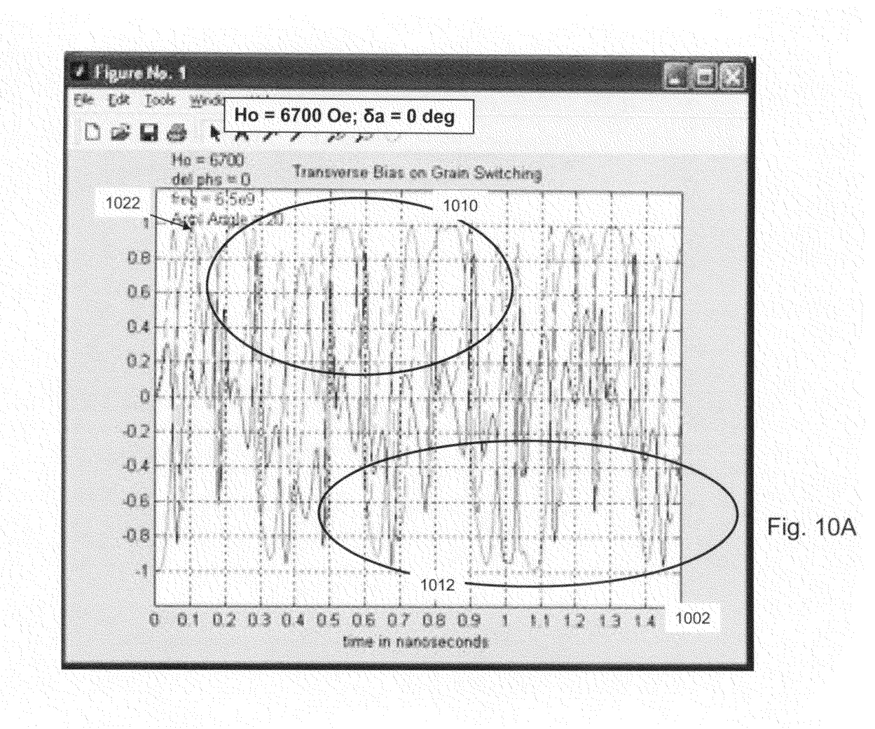

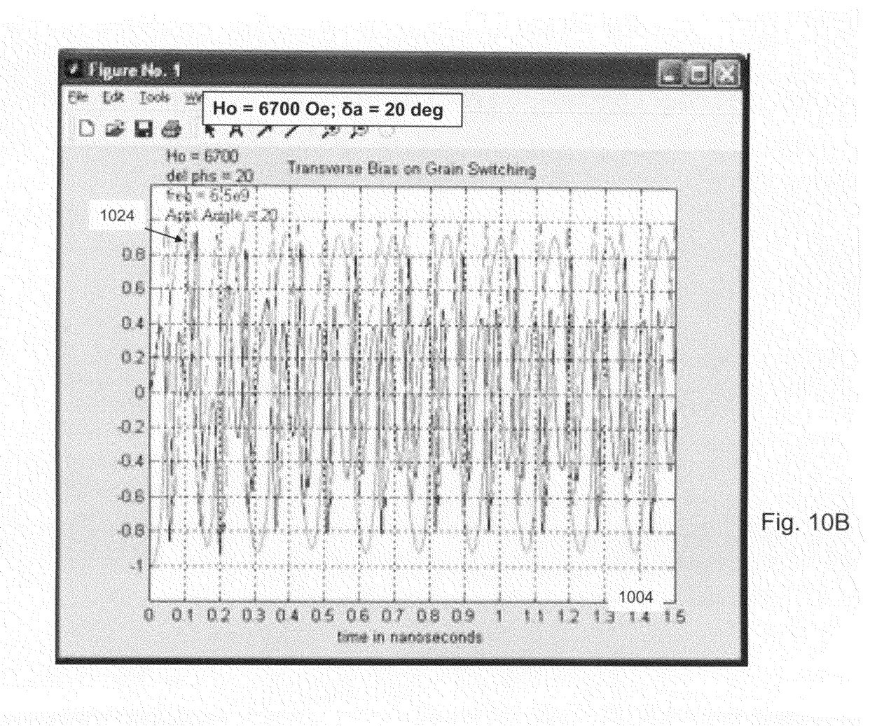

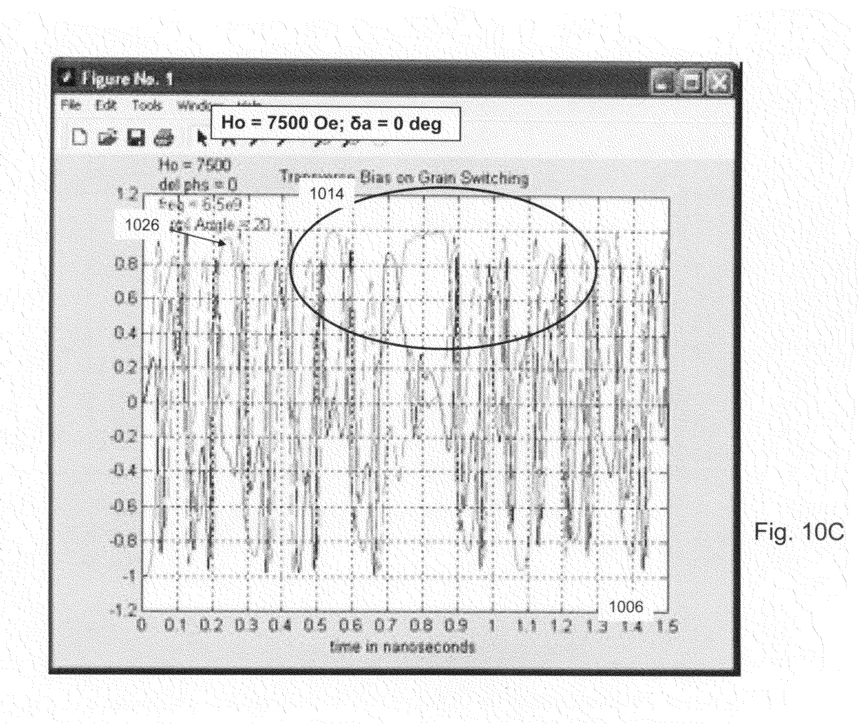

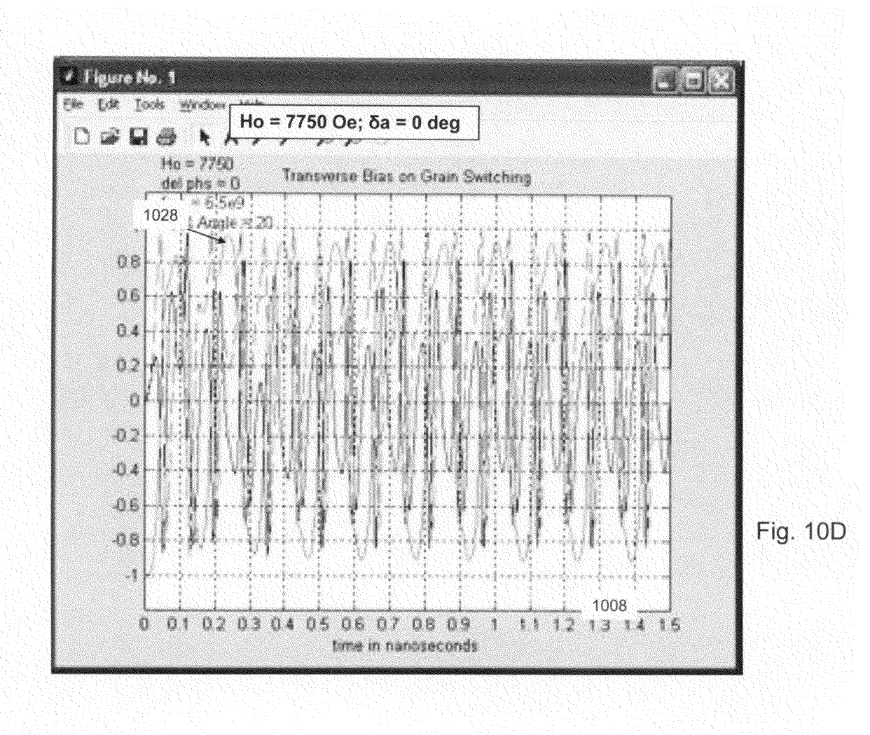

Shown in FIG. 10 are the results of simulating a switching frequency of a switching frequency of 6.5 GHz an applied angle from the z direction of 20 degrees. Rise time ratio is the ratio of H1_risetime to H2_risetime. Lines 1022, 1024, 1026, and 1028 in FIG. 10 correspond to the z-component of grain magnetization (normalized to 1). Graph 1002 shows the results of a leading phase δa of zero degrees with an applied field of 6.7 kOe; graph 1004 shows the results of a leading phase δa of 20 degrees with an applied field of 6.7 kOe. Graph 906 shows the results of a leading phase δa of zero degrees with an applied field of 7.5 kOe; graph 1008 shows the results of a leading phase δa of zero degrees with an applied field of 7.75 kOe.

Notable is that with δa of zero degrees significant problems are observed for an applied field of 6.7 kOe and 7.5 kOe as noted in circles 1010, 1012, and 1014 where complete magnetization switching is not achieved. It takes an applied field of 7.75 kOe as shown in graph 1008 to produce comparably efficient switching as shown in graph 1004 with a lower applied field (6.7 kOe) but with a δa of 20 degrees.

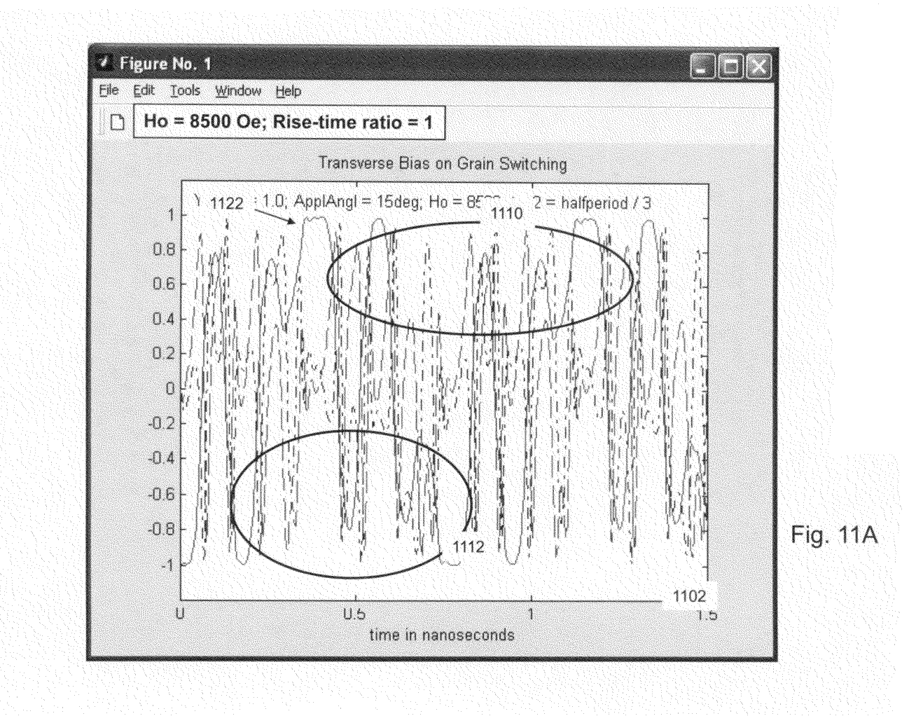

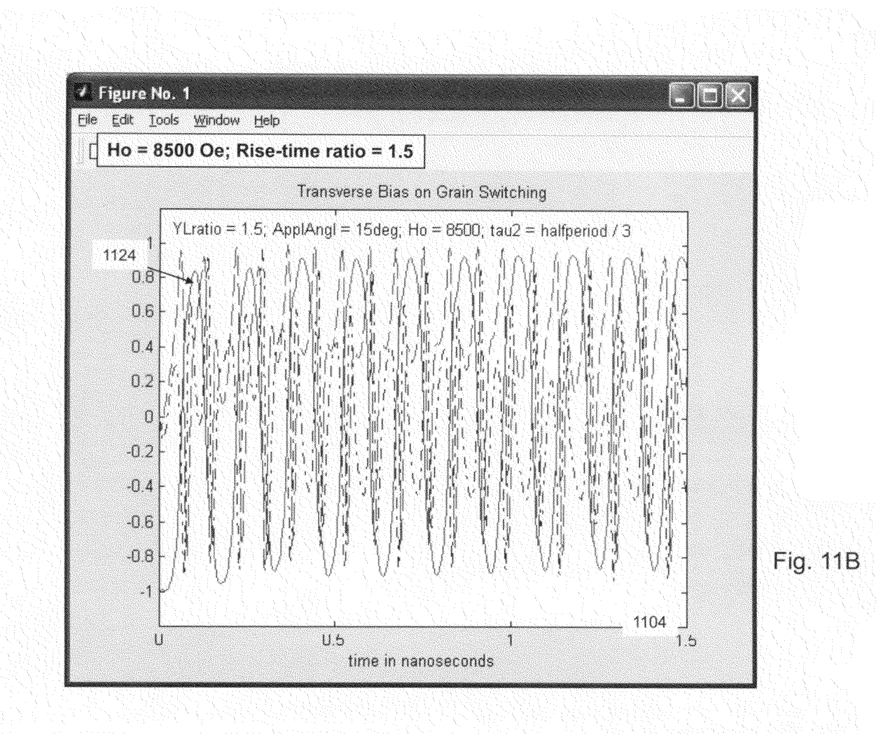

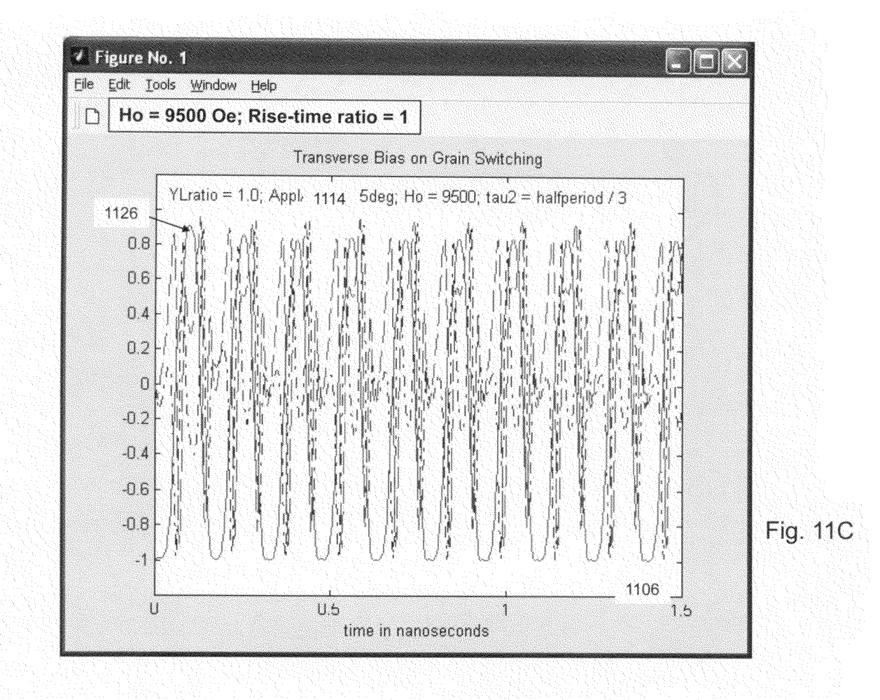

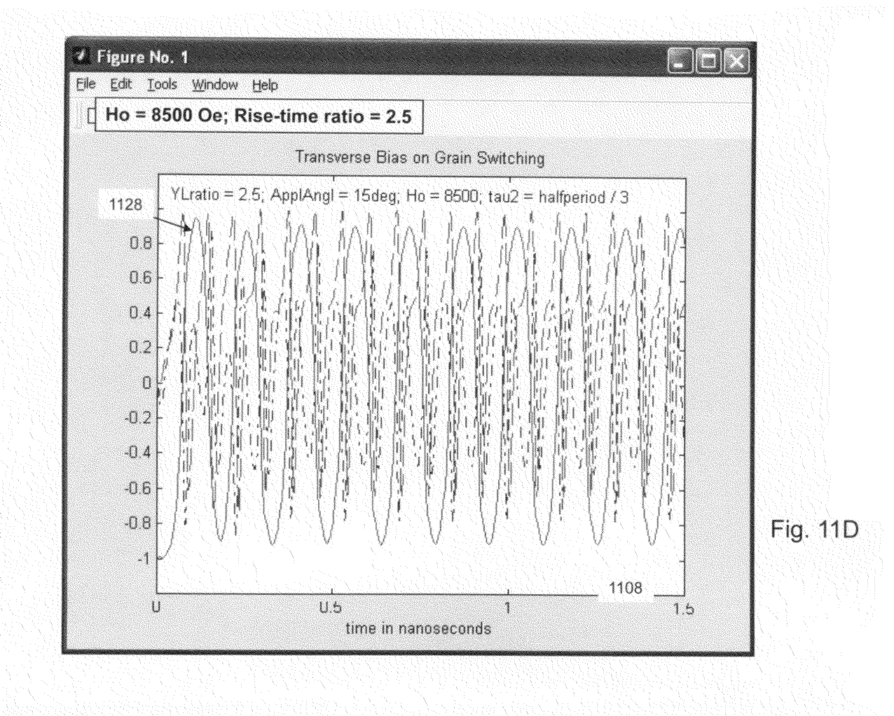

Shown in FIG. 11 are the results of simulating a switching frequency of a switching frequency of 6.5 GHz an applied angle from the z direction of 15 degrees. Also, H2_risetime is reasonably assumed to be equal to bit-length/3 (i.e., one-third of the bit length in time). For illustration, flux through the main-pole (Ho*main_pole_area) is assumed to be equally contributed by lower-return flux (H1*lower_return_pole_area) and upper-return flux (H2*upper_return_pole_area). It should be noted, however, that a larger contribution by lower-return flux (for example, by increasing the area of the lower return pole) provides further advantages in the rotational field of the present invention. Finally, rise time ratio is the ratio of H1_risetime to H2_risetime. Lines 1122, 1124, 1126, and 1128 in FIG. 11 correspond to the z-component of grain magnetization (normalized to 1).

With a rise-time ratio=1 (e.g., a conventional head), proper switching does not occur until Ho is above 9500 Oe such as shown in graphs 1102 (Ho=8500 Oe) and 1106 (Ho=9500 Oe). With a rise-time ratio between 1.5 and 2.5 as shown in graphs 1104 and 108, respectively, proper switching occurs at Ho=8500 Oe. From inspection of the curve 1126, it is arguable that with a rise-time ratio=1 (eg. a conventional head), even at Ho=9500 Oe, the quality (eg. symmetry) of the switching is inferior to that of rise-time ratio at 1.5 or 2.5 but with Ho only at 8500 Oe (curves 1124 & 1128).

A maximized effect is expected as demonstrated by the fact that at a rise-time ratio of 3, undesirable switching effects (not shown) are again seen. This simulation, therefore, demonstrates that there is a maximized effect occurs at a rise-time ratio of about 2.0+/−0.5. The maximized effect is, in any case, expected to vary with changed conditions such as a different H2_risetime or other factors. The discussed rise-time ratio may be pre-designed using the various methods mentioned elsewhere in this disclosure (eg. yoke-length ratio between upper and lower return-poles).

The above-described simulations, therefore, demonstrate that improved switching can be achieved with the rotational write field of the present invention.

A rotational write field can facilitate faster switching in media magnetization as well as reduce the total write field needed to switch a bit. For example, a rotational write field can be achieved with two separate coils that can be connected in parallel to a single set of write driving electronics and can also be implemented as two separate coils with independent write driving electronics.

The present disclosure provides a different manner of implementing a rotational write field, that is, a rotational write field through the use of a single write coil. A benefit of a single coil rotational write field is that it is generally straightforward to implement and is less demanding to write driving electronics.

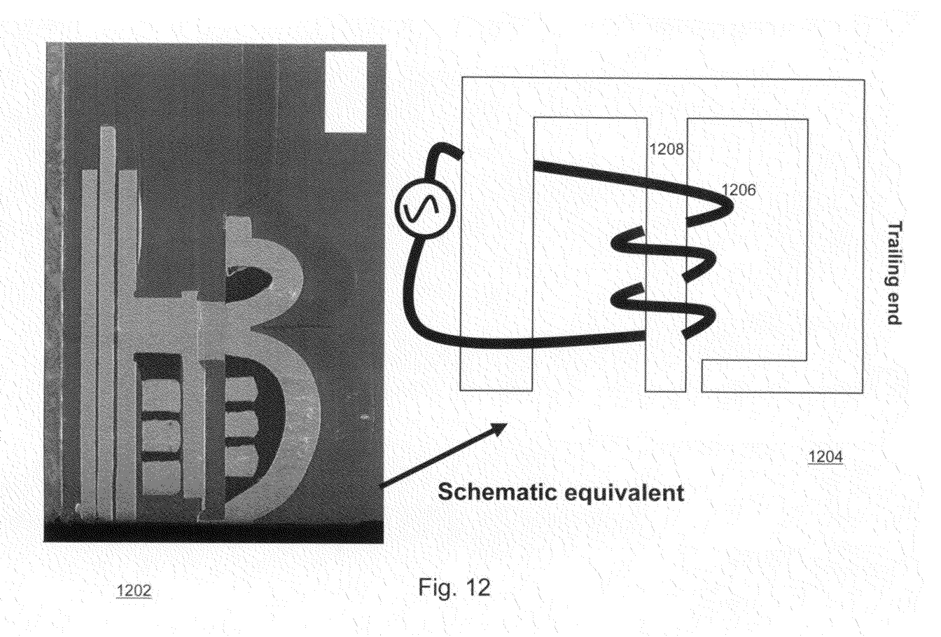

To understand certain of the benefits of the present invention, it is helpful to first understand a conventional writer. Shown in FIG. 12 is an SEM image of a conventional perpendicular writer 1202 and its schematic equivalent 1204. As shown in schematic 1204, a single helical coil 1206 is wrapped around a main pole 1208. The result of conventional write 1202 is, therefore, a perpendicular field Ho and top gap field Hg that are always in phase with a constant tilting angle.

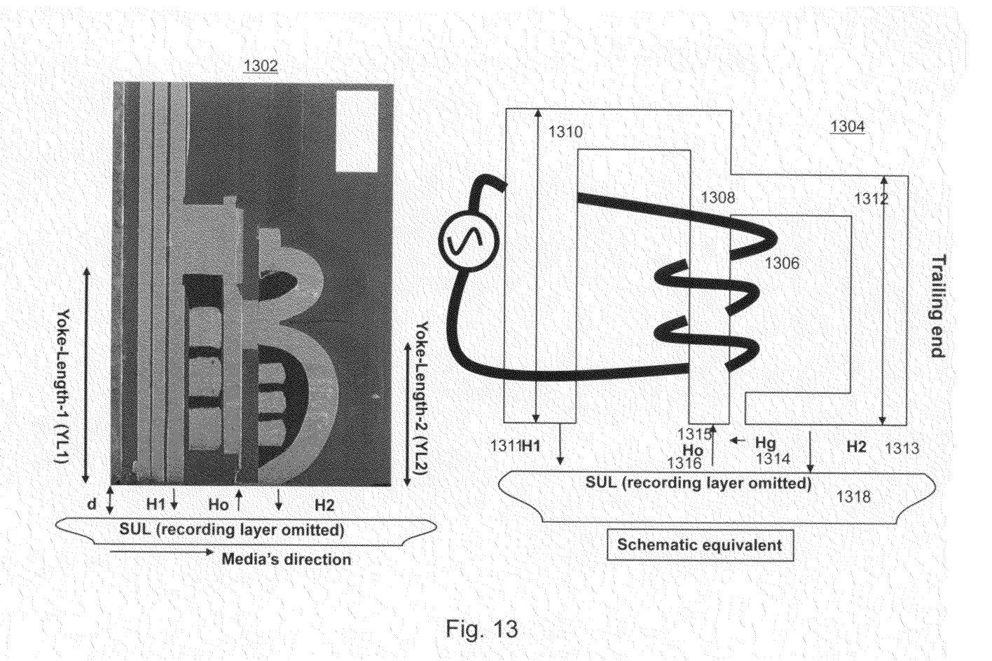

Shown in FIG. 13 is an edited picture of a perpendicular writer 1302 and its schematic equivalent 1304 according to an embodiment of the present invention that achieves a rotational write field with a single coil. Note that the image 1302 is an edited photograph that illustrates how an embodiment of the invention may appear. Image 1302, however, is not a photograph of an actual physical head. Also, note that schematic equivalent 1304 is presented for illustrative purposes and is not drawn to scale. As shown in FIG. 13, a single helical coil 1306 is wrapped around main pole 1308 where the yoke length 1310 of the lower (leading) return pole is longer than the length 1312 of the upper (trailing) return pole.

It has previously been shown that the flux rise time is proportional to

$$\frac{L}{NI}$$

where

L=yoke length,

N=number of coil turns, and

I=write current.

More specifically, the rate of flux change of the individual return poles is proportional to

$$\sqrt{\frac{NI ρ w2Bs}{L}}$$

while flux rise-time is proportional to

$$\frac{{BsLk}^{2}}{NI ρ}$$

where

ρ=resistivity,

Bs=saturation flux density,

w=width of pole,

k=thickness of pole,

L=yoke length,

N=number of coil turns, and

I=write current.

Thus, with the same NI but with different yoke lengths 1310 and 1312, the return field through the lower return pole H1 1311 will be slower than both the Hg 1314 and return field through the media 1318 and upper return pole H2 1313. Since Hg 1314 is in phase with H2 1313 while Ho 1315 is the sum of H1 1311 and H2 1313, the overall Ho 1315 will lag in phase behind Hg to generate rotating total field H_total.

To generate the desirable rotational magnetic field with a single coil, other properties of a writer can be manipulated. For example, the different yokes of the writer of the present invention can be made with different resistivity. In an embodiment of the invention, the resistivity of the upper return pole is made to be greater than the resistivity of the lower return pole. Also, the saturation flux density (Bs) or the pole width (w) or the pole thickness (k) can be varied. In an embodiment of the invention, the saturation flux density of the upper return pole is made greater than the saturation flux density of the lower return pole. In still another embodiment of the invention, the width of the lower return pole is made greater than the width of the upper return pole. In still another embodiment of the invention, the thickness of the lower return pole is made greater than the thickness of the upper return pole, and could also be coupled with a longer lower return pole. In general, a larger cross-sectional area of the lower return pole, either by larger thickness or larger width, provides advantageous effects for the rotational field of the present invention.

One of ordinary skill in the art is, therefore, able to appreciate that many combinations can be achieved by manipulating the characteristics of a rotational field writer according to the present invention. For example, the yoke length, resistivity, saturation flux density, width, coil turns and other characteristics may be varied to achieve the rotational write field of the present invention. In general, a larger area of the lower return pole exposed to the air-bearing-surface (ABS), either with a larger thickness or other means, provides advantageous effects for the rotational field of the present invention.

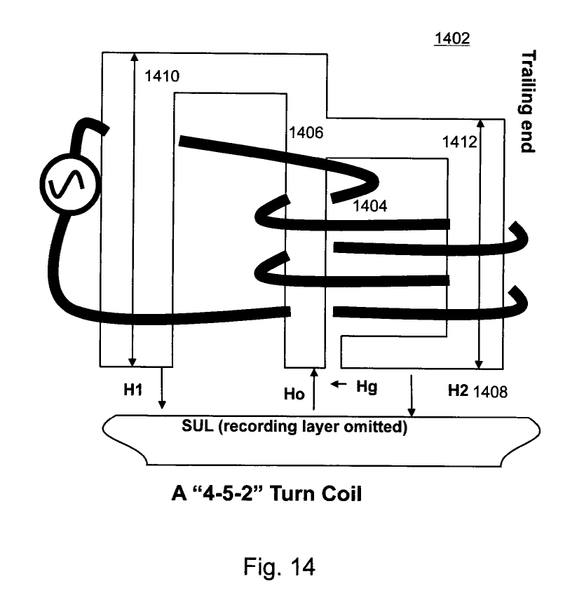

Yet another embodiment of the invention that achieves a rotational write field using a single coil is shown in FIG. 14. As shown, writer 1402 is made with a single coil 1404 in a more elaborate winding. Single coil 1404 corresponds to having four turns winding around the main pole 1406 with two additional turns on the trailing side of the upper return pole 1408. The turns on upper return pole 1408 assist in decreasing the rise time that would otherwise be created with just the implementation of different yoke lengths 1410 and 1412. Advantageously, the turns on upper return pole 1408 are also able to be positioned closer to the front of upper return pole 1408 to further decrease the rise time.

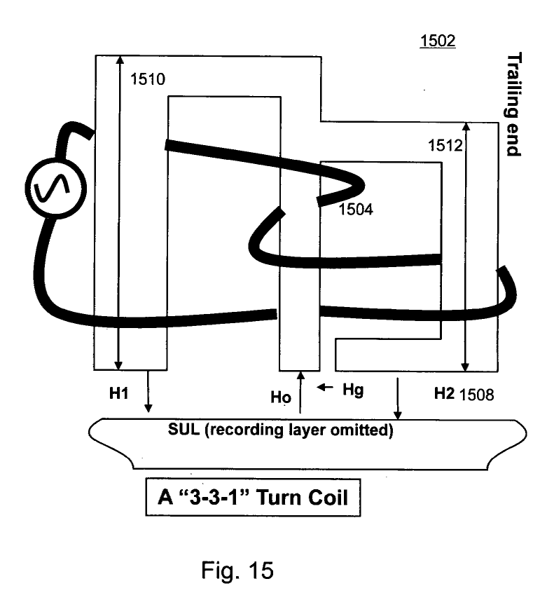

Yet another embodiment of the invention that achieves a rotational write field using a single coil is shown in FIG. 15. As shown, writer 1502 is made with a single coil 1504 in a different configuration. Single coil 1504 corresponds to having three turns winding around the main pole 1506 with an additional turn on the trailing side of the upper return pole 1508. The turn on upper return pole 1508 assists in decreasing the rise time that would otherwise be created with just the implementation of different yoke lengths 1510 and 1512. Advantageously, the turn on upper return pole 1508 is also able to be positioned closer to the front of upper return pole 1408 to further decrease the rise time.

One of ordinary skill in the art is, therefore, able to appreciate that many combinations can be achieved by manipulating the windings of a rotational field writer according to the present invention.

It should be appreciated by those skilled in the art that the specific embodiments disclosed above may be readily utilized as a basis for modifying or designing other write elements. It should also be appreciated by those skilled in the art that such modifications do not depart from the scope of the invention as set forth in the appended claims.

What is claimed is:

1. A perpendicular magnetic write head, comprising:
a main pole;
an electrically conductive coil coupled to the main pole configured to generate a magnetic flux in the main pole;
write driving circuitry coupled to the electrically conductive coil;
a leading return pole having a first set of attributes; and
a trailing return pole having a second set of attributes,
wherein the first and second attributes are configured to develop a leading phase magnetic field through the trailing return pole during a write operation.

2. The write head of claim 1, wherein the first set of attributes includes a first yoke length and the second set of attributes includes a second yoke length that is shorter than the first yoke length.

3. The write head of claim 1, wherein the first set of attributes includes a first resistivity and the second set of attributes includes a second resistivity that is higher than the first resistivity.

4. The write head of claim 1, wherein the first set of attributes includes a first thickness and the second set of attributes includes a second thickness that is smaller than the first thickness.

5. The write head of claim 1, wherein the first set of attributes includes a first area exposed to an air-bearing-surface and the second set of attributes includes a second area exposed to the air-bearing-surface that is smaller than the first area.

6. The write head of claim 1, wherein the first set of attributes includes a first flux rise time and the second set of attributes includes a second flux rise time that is shorter than the first flux rise time.

7. A perpendicular magnetic write head, comprising:
a main pole;
an electrically conductive coil coupled to the main pole configured to generate a magnetic flux in the main pole;
write driving circuitry coupled to the electrically conductive coil;
a leading return pole configured to have a first flux rise time; and
a trailing return pole configured to have a second flux rise time,
wherein the second flux rise time is shorter from the second flux rise time.

8. The write head of claim 7, wherein the leading return pole has a first yoke length and the trailing return pole has a second yoke length that is shorter than the first yoke length.

9. The write head of claim 7, wherein the leading return pole has a first resistivity and the trailing return pole has a second resistivity that is lower than the first resistivity.

10. The write head of claim 7, wherein the leading return pole has a first thickness and the trailing return pole has a second thickness that is smaller than the first thickness.

11. The write head of claim 7, wherein the leading return pole has a first area exposed to an air-bearing-surface and the trailing return pole has a second area exposed to the air-bearing-surface that is smaller than the first area.

12. The write head of claim 7, wherein the electrically conductive coil is further coupled to the trailing pole in a configuration to reduce the second flux rise time.

13. A perpendicular magnetic write head, comprising:
a main pole;
an electrically conductive coil coupled to the main pole configured to generate a magnetic flux in the main pole;
write driving circuitry coupled to the electrically conductive coil;
a leading return pole having a first yoke length; and
a trailing return pole having a second yoke length,
wherein the second yoke length is shorter than the first yoke length, and
wherein the trailing return pole is configured to have a magnetic field whose phase leads a magnetic filed of the leading return pole.

14. The write head of claim 13, wherein the leading return pole has a first resistivity and the trailing return pole has a second resistivity that is lower than the first resistivity.

15. The write head of claim 13, wherein the leading return pole has a first thickness and trailing return pole has a second thickness that is smaller than the first thickness.

16. The write head of claim 13, wherein the leading return pole has a first area exposed to an air-bearing-surface and the trailing return pole has a second area exposed to the air-bearing-surface that is smaller than the first area.

17. The write head of claim 13, wherein the leading return pole has a first flux rise time and the trailing return pole has a second flux rise time that is shorter than the first flux rise time.

18. A perpendicular magnetic write head, comprising:
a main pole;
an electrically conductive coil coupled to the main pole configured to generate a magnetic flux in the main pole;
write driving circuitry coupled to the electrically conductive coil;
a leading return pole having a first flux rise time; and
a trailing return pole having a second flux rise time,
wherein electrically conductive coil is further coupled to the trailing return pole in a configuration where the second flux rise time is shorter from the first flux rise time.

19. The write head of claim 18, wherein the leading return pole has a first yoke length and the trailing return pole has a second yoke length that is shorter than the first yoke length.

20. The write head of claim 18, wherein the leading return pole has a first resistivity and the trailing return pole has a second resistivity that is lower than the first resistivity.

21. The write head of claim 18, wherein the leading return pole has a first thickness and the trailing return pole has a second thickness that is lower than the first thickness.

22. The write head of claim 18, wherein the leading return pole has a first area exposed to an air-bearing surface and the trailing return pole has a second area exposed to the air-bearing surface that is smaller than the first area.
